(19) United States
(12) Patent Application Publication
(10) Pub. No.: US 2026/0169515 A1
(43) Pub. Date: Jun. 18, 2026

(54) DISTRIBUTED PROCESSING AND SYNCHRONIZATION OF DSPS FOR EFFICIENT CROSSBAR CONTROL AND TRAFFIC HANDLING

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/418,797

(22) Filed: Dec. 12, 2025

Related U.S. Application Data
(60) Provisional application No. 63/734,024, filed on Dec. 13, 2024.

(51) Int. Cl. G06F 1/04

(52) U.S. Cl. CPC G06F 1/04

(57) ABSTRACT

A digital signal processors (DSPs) and analog crossbars operatively connected to the DSPs includes a method for synchronization and distributed processing. The DSPs are configured to coordinate traffic among themselves, enabling efficient data flow and resource allocation. This coordination may involve synchronization, traffic management, and resource arbitration to optimize performance and minimize latency. The device facilitates seamless communication and supports dynamic reconfiguration, making it suitable for high-speed networking and scalable systems.

### RELATED APPLICATION

This application claims the benefit of U.S. Provisional Application No. 63/734,024, filed Dec. 13, 2024, the disclosure of which is incorporated herein by reference in its entirety.

The examples discussed in the present disclosure are related to distributed processing and synchronization of DSPs for efficient crossbar control and traffic handling.

### BACKGROUND

Unless otherwise indicated herein, the materials described herein are not prior art to the claims in the present application and are not admitted to be prior art by inclusion in this section.

Datacenters, artificial intelligence (AI) clusters, and high-performance computing environments increasingly require reliable, low-latency communication for managing vast amounts of data across distributed systems. Traditional Ethernet switches, which rely on packet-switched networks, often exhibit variable delivery times, unreliable performance, and significant latency, making them unsuitable for certain critical applications. To address these challenges, fabric switches have emerged as a viable alternative.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

Some examples herein include systems and methods for efficient traffic coordination in high-speed networks. The device includes digital signal processors (DSPs) and analog crossbars, with the DSPs configured to coordinate traffic among themselves through synchronization, mutual exclusion, and backpressure mechanisms. These features enable dynamic reconfiguration, seamless communication, and optimized resource allocation. A device may include digital signal processors (DSPs) and analog crossbars connected to the DSPs. The DSPs may coordinate traffic between the DSPs. A device may include a DSPs, analog crossbars connected to the plurality of DSPs, and a switch controller to coordinate traffic between the DSPs. A method may include connecting DSPs to analog crossbars, and coordinating traffic between the DSPs.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1A illustrates an example device including digital signal processors and analog crossbars, in accordance with some examples;

FIG. 1B illustrates an example device including a digital signal processor, in accordance with some examples;

FIG. 2 illustrates an example device including digital signal processors and analog crossbars, in accordance with some examples;

FIG. 3 illustrates an example device including a plurality of digital signal processors (DSPs) and a plurality of analog crossbars with redundancy.

FIG. 4 illustrates an example timing diagram used for coordinating traffic, in accordance with some examples;

FIG. 5 illustrates an example process flow of a device for coordinating traffic, in accordance with some examples;

FIG. 6 illustrates an example communication system operable for coordinating traffic, in accordance with some examples; and

FIG. 7 illustrates a diagrammatic representation of a machine in the example form of a computing device, in accordance with some examples.

FIG. 8A illustrates an example block diagram of a data center.

FIG. 8B illustrates an example switch device.

FIG. 8C illustrates an example switch device.

FIG. 8D illustrates an example switch device.

### DETAILED DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

Distributed processing allows for better resource management and scalability. High traffic loads may be handled using parallel processing. In addition, distributed processing (e.g., at a digital signal processor) may manage crossbar configurations. Synchronization across DSPs may be used to facilitate resource management. Collision avoidance may be facilitated by using distributed processing. As a result, switch configuration time may have a reduced latency when compared to a baseline latency. In-band signaling of crossbar reconfiguration may allow for a fast protocol that may be backward compatible. Interaction with crossbar endpoints (e.g., clients) may allow for priority, resource requests, and resource grants.

Examples of the described herein will be explained with reference to the accompanying drawings.

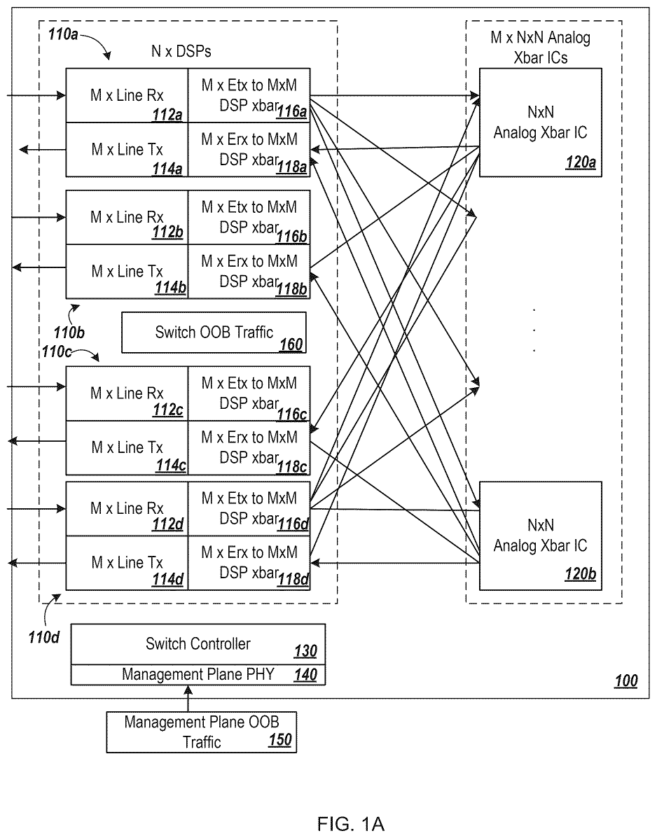

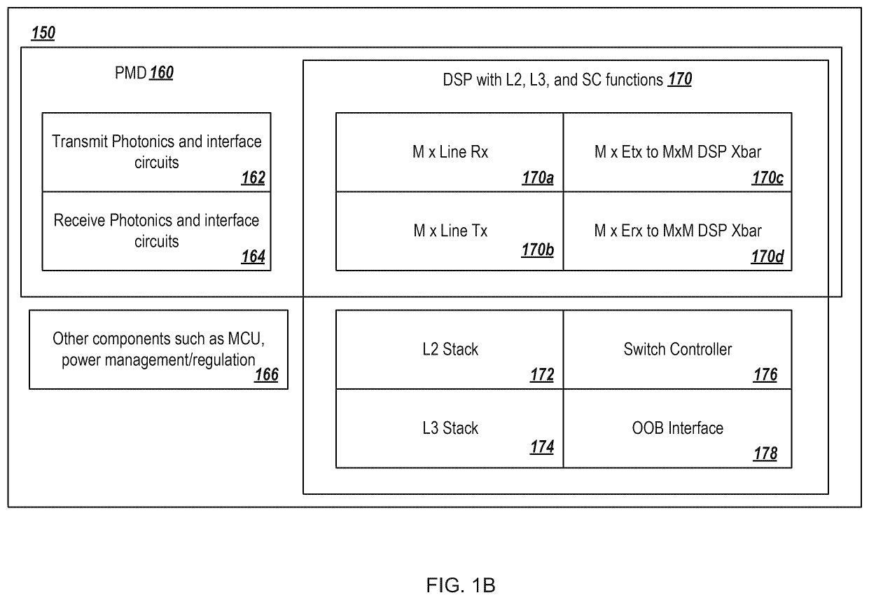

As illustrated in FIG. 1A, an analog electrical circuit switch (AECS) may include one or more DSPs 110a, 110b, 110c, 110d. The AECS may include a switch controller 130. The AECS may include one or more analog crossbar (“xbar”) integrated circuits (IC) (e.g., analog crossbars 120a, 120b). In some examples, alternatively or in addition, the AECS may include one or more digital crossbars that may be coupled to the one or more DSPs 110a, 110b, 110c, 110d.

DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP.

Switch out-of-band (OOB) traffic may be traffic among the SC 130, DSP 110a, 110b, 110c, 110d, analog crossbars 120a, 120b carried on a different network and physical layer than IB; may be carried on analog crossbars 120a, 120b with redundancy.

An “Xbar IC” may be an analog Xbar IC which may be a chip implementing an analog crossbar with input and output lanes. In some examples, alternatively or in addition, the Xbar IC may be one or more digital crossbars.

Management plane OOB traffic may be traffic from outside the AECS via management plane PHY to configure and manage the AECS.

Low-latency switching may be facilitated by using in-band L2 (or L3) stack which may include frame processing and/or packet header processing. At the level of a PMD, packet inspection and crossbar control may be facilitated by using layers 1 to 3 to support in-band control. As a result, reconfiguration times may be faster when compared to a baseline time in which layers 1 to 3 are not used to support in-band control. Because a PMD (e.g., a DSP) may have access to packets and/or frames as soon as they arrive, latency may be reduced when compared to a baseline latency. A PMD (e.g., a DSP) may have built-in crossbar functionality which may be used for a switch. In addition, the PMD (e.g., the DSP) may allow for efficient distributed processing of headers, packet inspection, and/or frame inspection. To facilitate efficient AECS resource allocation, synchronization and coordination between DSPs may be used.

As illustrated in FIG. 1B, a module 150 may include a PMD 160. The PMD 160 may have functionality which may transmit photonics and interface circuits 162 and/or may receive photonics and/or interface circuits 164. The PMD 160 may include other components such as an MCU, power management, and/or power regulation. The PMD 160 may include a DSP 170. The DSP 170 may include various functions including an L2 stack 172, an L3 stack 174, a switch controller 176, and/or an OOB interface 178.

The L2 stack 172, L3 stack 174, switch controller 176, and OOB interface 178 may be on the same chip as the L1 functions (i.e., a one die implementation) or the L2 stack 172, L3 stack 174, switch controller 176, and OOB interface 178 may be on a different chip from L1 functions (e.g., a chiplet implementation with a silicon or organic interposer). Proximity to L1 functions may be used for power savings because of the reduced cost of input and output.

A PMD (e.g., DSP) that may process L2 and/or L3 protocols may include, for example, frame headers, packet headers, frame boundaries, medium access control (MAC) addresses, internet protocol (IP) addresses, the like, or a combination thereof. Alternatively or in addition, IP routing and/or protocol processing may be implemented in a PMD (e.g., a DSP). The PMD (e.g., DSP) may configure itself or the PMD (e.g., DSP) may be configured by a system that is connected to the PMD (e.g., DSP). The PMD (e.g., DSP) may responds to packets and/or frames addressed to the PMD (e.g., DSP) using e.g., in-band communication. The PMD (e.g., DSP) may respond to specific L2 or L3 requests. Responses may include responding to a request from another system through L1-L3 signaling (e.g., sending packets containing requested information such as status of the DSP and system). Responses may include sending L2 and/or L3 messages back to a requestor (e.g., without waiting for additional processing by a system external to the DSP such as an MCU or AECS processor.

A PMD (e.g., DSP) may integrate L2 and/or L3 capabilities (e.g., MAC address tables, IP routing tables, priority levels for such table entries, as well as crossbars controllable through L1, L2 or L3). The PMD (e.g., DSP) may store, update, communicate, or process information used as part of L2 or L3 communication/request. For example, PMD (e.g., DSP) may receive a communication containing a frame header or packet header addressed to the PMD (e.g., DSP), detect and decode the header as well as the associated contents within the PMD (e.g., DSP). In another example, the PMD (e.g., DSP) may integrate a MAC address lookup table (LUT) which may allow the PMD (e.g., DSP) to configure a crossbar or crossbars to provide connectivity between two MAC addresses in the LUT.

A PMD (e.g., DSP) may store and manage routing information and crossbar control information to facilitate intelligent data routing. The PMD (e.g., DSP) may store, update, communicate, and/or optimize information to fulfill a L2 or L3 request. The PMD (e.g., DSP) may change the way in which communication traffic is directed (e.g. configuring an internal or external switch or crossbar based on L1-L3 processing). A DSP may have an LUT which may store the equalization settings for a plurality of connections (e.g., crossbar settings) in order to speed up acquisition and tracking when switching from one connection to another. The DSP may respond to L2 and/or L3 requests for connectivity or resource grant requests e.g., by comparing those requests to a table of L2/L3 priority levels and configuring itself (i.e., the DSP), DSP crossbars, and/or crossbar ICs, based on priority levels within tables.

A DSP may respond to a management plane request by e.g., sending via management plane to SC, which configures DSP tables or the like or by e.g., configuring DSP crossbars or crossbar ICs in response to the contents of the communication and/or the LUT(s).

A DSP may respond to IB requests based on contents of the communication and/or LUT(s), such as granting a connection request or signaling backpressure to a Client. A DSP may collect statistics on traffic for link utilization, type of traffic flowing through DSP (which may perform classification of traffic). A DSP may perform data filtering by looking for specific header, frame, or packet content/routing. A DSP may generate a management plane flag, interrupt, or alert A DSP may communicate said flag/interrupt/alert through SC to management plane. A DSP may log such flag-interrupt/alert.

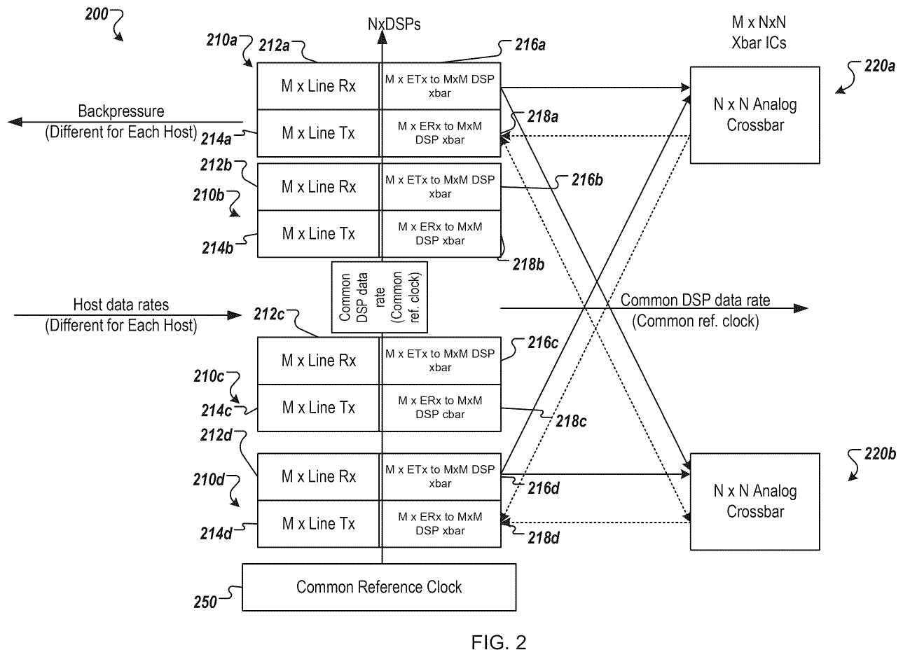

As illustrated in FIG. 2, a device 200 may include DSPs 210a, 210b, 210c, 210d that may include various functionality. For example, DSP 210a may include M×Line Rx 212a, M×Line Tx 214a, M×ETx to M×M DSP crossbar 216a, and M×ERx to M×M DSP crossbar 218a. For example, DSP 210b may include M×Line Rx 212b, M×Line Tx 214b, M×ETx to M×M DSP crossbar 216b, and M×ERx to M×M DSP crossbar 218b. For example, DSP 210c may include M×Line Rx 212c, M×Line Tx 214c, M×ETx to M×M DSP crossbar 216c, and M×ERx to M×M DSP crossbar 218c. For example, DSP 210d may include M×Line Rx 212d, M×Line Tx 214d, M×ETx to M×M DSP crossbar 216d, and M×ERx to M×M DSP crossbar 218d. Device 200 may also include analog crossbars 220a, 220b. In some examples, alternatively or in addition, the device 200 may include one or more digital crossbars. Device 200 may have a common reference clock 250.

A device 200 may include DSPs 210a, 210b, 210c, 210d and analog crossbars 220a, 220b. In some examples, alternatively or in addition, the AECS may include one or more digital crossbars that may be coupled to the one or more DSPs 110a, 110b, 110c, 110d. The DSPs may coordinate traffic between the DSPs. The DSPs may coordinate one or more of a state or a configuration between DSPs. That is, multiple DSPs may coordinate states and configurations to facilitate seamless traffic flow and optimized resource allocation. Coordinating states and/or configurations may include L2 and/or L3 information such as routing, switch configurations, up-to-date priorities, or the like. The DSP may use L2 capability to establish and communicate a schedule for resource allocation. The DSPs may establish a synchronous resource allocation cycle similar to medium access protocol (MAP) cycle between DSP and a Client, or across multiple DSPs in a system. Coordinating traffic between DSPs may facilitate handling of data streams without central coordination.

The DSPs may coordinate configurations between DSPs such as crossbar configurations. Coordinating configurations may allow for low-latency switching. The distribution and coherency of the state of the AECS may be communicated within modules. As a result, there may be a fast response to resource requests.

The DSPs may be coordinated using one or more of IB communication or OOB communication. In-band communication may allow a client to communicate with an AECS synchronized with payload data and may leverage existing PHY connectivity.

The DSPs may be coordinated using asynchronous coordination. That is, an asynchronous resource allocation scheme may be used. In this example, time division multiplexing may not be used. In addition or alternatively, crossbars may be reconfigured based on the control plane. The control plane may communicate with the SC to set the crossbar configuration.

The DSPs may be coordinated using ad hoc communication. Alternatively or in addition, DSPs may be coordinated using a designated SC (e.g., at an DSP or as a separate SC).

The DSPs may handle contention using mutual exclusion. Mutual exclusion (Mutex) may prevent contention to facilitate fast and efficient resource allocation. For example, lane 8, port 8 may have a select amount of bandwidth to reserve (e.g., 10%). Port 2, lane 2 may use the select amount of bandwidth that is available. Port 2, lane 3 may use the bandwidth when it becomes available. Therefore, low-latency traffic routing may occur. Mutex may prevent multiple access of the shared resource at the same time and may prevent collisions.

A switch controller may coordinate traffic between the DSPs. The switch controller may be a separate component or may be a DSP.

The connections between the DSPs and the analog crossbars may be periodically changed to facilitate communication. For example, the way in which the end points of the DSPs and the end points of the analog crossbars connect to may be changed (e.g., periodically) to facilitate communication. LUTs may be used to store DSP and/or analog crossbar configurations for different crossbar connection configurations.

One or more crossbar inputs may be provisioned to facilitate control and management of the device (e.g., the AECS). Additional crossbar inputs may be provisioned to enable IB or OOB switch control and management. PMDs (e.g., DSPs) may grant immediate provisional (temporary) bandwidth based on locally cached network state (e.g. priorities, connectivity). More bandwidth may be granted subsequently after switch controller resolves potential resource contention, determines alternate routings, and the like. Therefore, there may be a provisional means for resolving collisions and/or contention across DSPs. For example, if two clients request bandwidth to the same endpoint with the same level of priority, then a provisional means may be used to resolve the collision and/or contention. The resolution may involve granting a lower bandwidth initially, followed by more bandwidth if there is not collision and/or contention.

A device may include DSPs, analog crossbars connected to the DSPs, and a switch controller. The DSP may be designated as a switch controller. Alternatively, a separate device such as an MCU may be used for this purpose.

The SC may facilitate failover. The SC may have failover functionality (e.g., providing for a successor in the event of failure, provisions for detecting failure, or the like). The fail-over functionality may support default route and “dirty bit marking” to control the switch over to the alternative path.

The SC may reserve in-band bandwidth and/or network resources e.g., to provide predictable communication. The SC may reserve IB bandwidth for predictable link behavior or latency. The SC may use idle symbols detected in physical coding sublayer (PCS). The SC may insert in-band communication or perform foreground calibration. The SC may allocate crossbar resources for predicted or anticipated traffic, e.g. based on a probabilistic model. The SC may use OOB communications such as inter-integrated circuit (I2C), serial peripheral interface (SPI), reduced gigabit media independent interface (RGMII), 10G serializer/deserializer (SERDES), Ethernet, or the like. Star or daisy-chained topologies, or crossbar connectivity may be used for OOB.

Transmit (TX) Path determination may use dynamic method of AECS XBAR from IN to final OUTPUT (e.g., by allowing consecutive frames with “repeat” flag to go through same path omitting other information (dynamic bandwidth optimization)).

A switch controller may have various functions. The switch controller may resolve resource grant requests and function as an arbiter of contention. The switch controller may distribute network state (establishing coherency among DSPs). The switch controller may be a repository of current network state information (e.g. MAC tables, priority assignments). The switch controller may be a timing master by establishing time base, e.g. MAP cycles across DSPs

The switch controller may connect in various ways. A controller may be a separate MCU or may be within a designated DSP or may be located as digital circuitry on a designated crossbar circuit. Various topologies may be used (e.g., star, mesh, daisy chain, or the like). The controller may support multiple instances to allow for coherency. Multiple controller systems may support a primary and secondary architecture to resolve conflicts across system instances.

Switch management and control may use various methods. In one example, IB control may involve a client communicating with the AECS via IB bandwidth by addressing DSPS and/or SC directly. Packet or frame headers may be inspected by the DSP for routing within the AECS or sent to the switch controller. In another example, the control plane physical layer may involve a client signaling the AECS using a separate network connection carrying control plane traffic.

The DSPs may synchronize the DSPs using a shared time base to minimize latency and timing drift during a traffic transition. The DSPs may be synchronized in time using Institute of Electrical and Electronics Engineers (IEEE) 1588. Alternatively or in addition, the DSPs may have a shared clock. The DSPs may be time synchronized and may operate with synchronous MAP cycles. The DSPs may have slightly different baud which may result in using a clock recovery unit. When DSPs are temporarily disconnected, reacquisition (“reacq”) may occur. Some time may be saved because channel is static; thus feed forward equalization (FFE) and continuous time linear equalization (CTLE) may be unchanged

The DSPs may use backpressure to avoid one or more of a data overflow or a collision between the DSPs. PMDs (e.g., DSPs) may implement queueing specifically for network resource sharing as well as provide backpressure/flow control (L2 function) e.g., to allow sharing of a given output port's bandwidth through time division multiplexing. Adjustable queue depth based on latency of traffic. Input queuing may be synchronized with switch reconfiguration and output queuing.

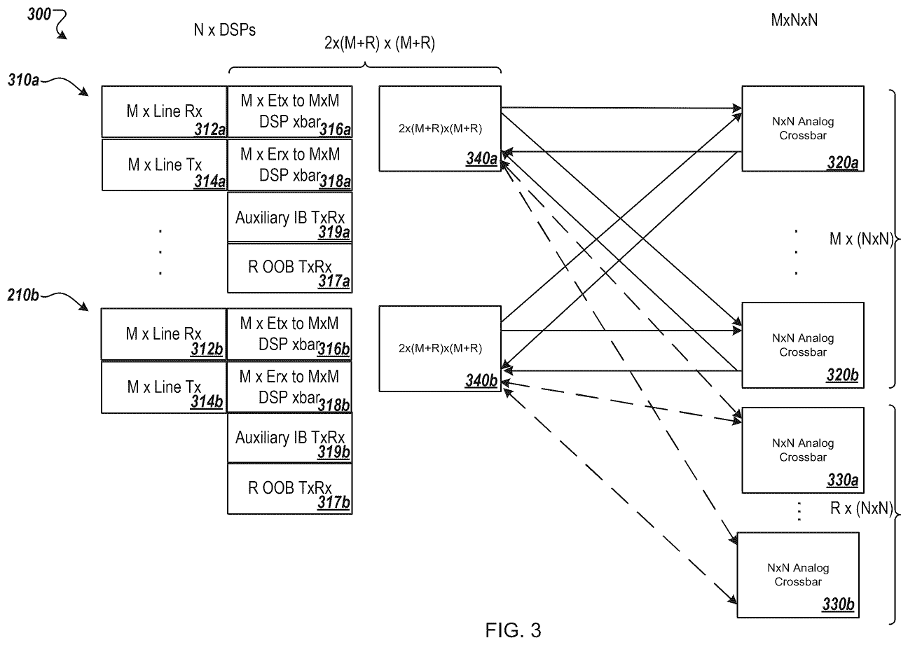

In one example, one or more crossbar inputs may be provisioned to facilitate control and management of the device, as illustrated in a device 300 in FIG. 3. One or more auxiliary in-band transceivers (aux IB Tx/Rx) 319a, 319b may be included in the DSPs 310a, 310b. The aux IB channel may be the same as the other IB channels. The aux IB Tx/Rx 319a, 319b may use the redundant analog crossbars 330a, 330b to communicate with other devices. The aux IB Tx/Rx 319a, 319b may be used to communicate or combine IB traffic, e.g., from one or more of the DSPs IB lanes.

The DSPs 310a, 310b may also have the functionality previously discussed including M×Line Rx 312a, 312b, the M×Line Tx 314a, 314b, the M×ETx to M×M DSP xbar 316a, 316b, and the M×ERx to M×M DSP xbar 318a, 318b. The DSPs 310a, 310b may also have crossbar functionality 340a, 340b. In addition, the DSPs may have OOB Tx/Rx 317a, 317b.

The analog crossbars 320a, 320b may receive IB switch traffic. The analog crossbars 320a, 320b may communicate IB switch traffic from an output.

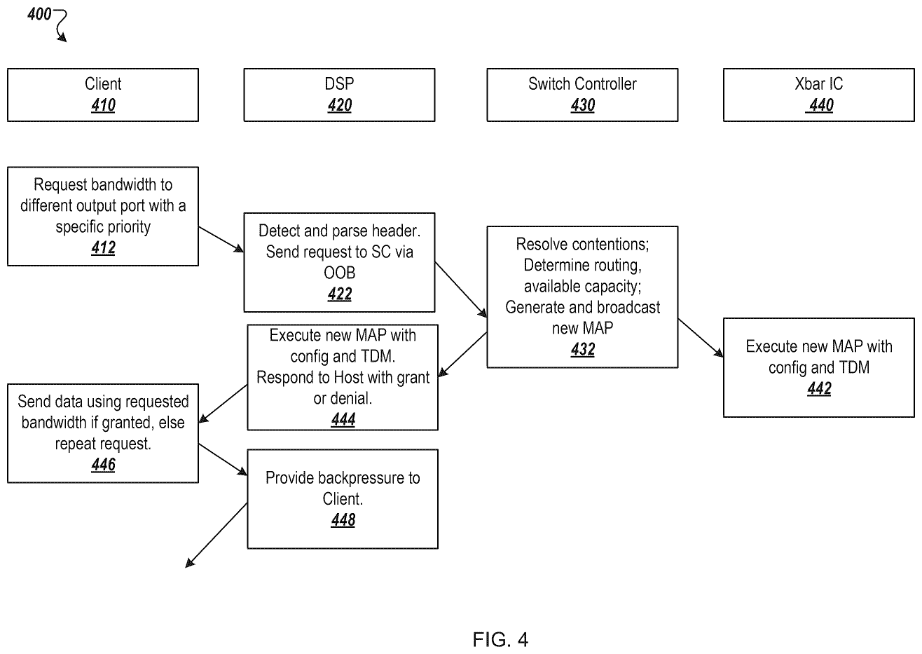

As illustrated in FIG. 4, a timing diagram 400 showing communication between a client 410, a DSP 420, a switch controller 430, and a crossbar IC 440 (i.e., including analog crossbars) is illustrated. The client 410 may communicate with DSP 420 by requesting bandwidth to a different output port with a specific priority, as in block 412. DSP 420 may detect and parse the header and send a request to the switch controller 430 via out-of-band communication, as in block 422. Switch controller 430 may resolve contentions, determine routing and available capacity, and generate and broadcast new MAP, as in block 432. Crossbar IC 440 may execute the new MAP with configuration and time division multiplexing (TDM), as in block 442. DSP 420 may execute new MAP with configuration and TDM, and respond to the host with grant or denial, as in block 444. The client 410 may send data using requested bandwidth if granted, or else repeat the request, as in block 446. DSP 420 may provide backpressure to client 410, as in block 448.

In addition or alternatively, the AECS may be an optical circuit switch (OCS). Any technique suitable for an AECS may be applied to an OCS.

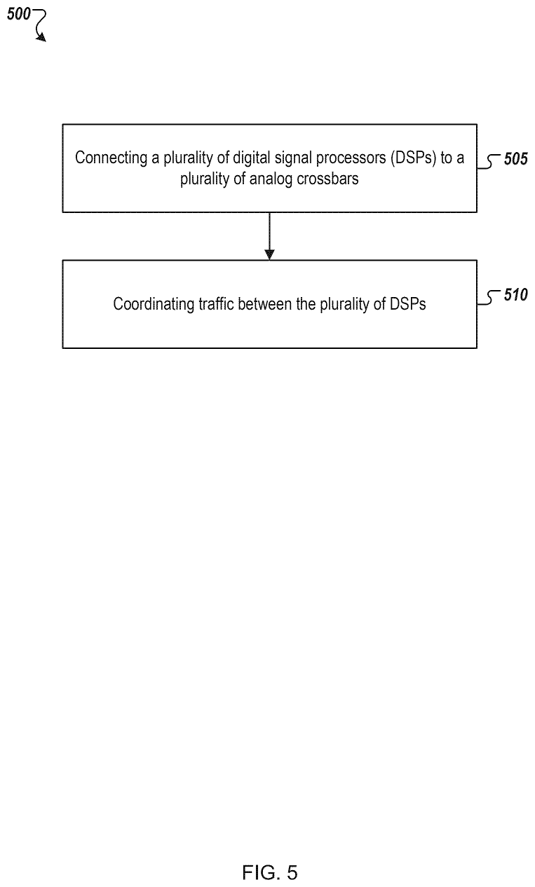

FIG. 5 illustrates a process flow of an example method 500 of traffic coordination, in accordance with at least one example described in the present disclosure. The method 500 may be arranged in accordance with at least one example described in the present disclosure.

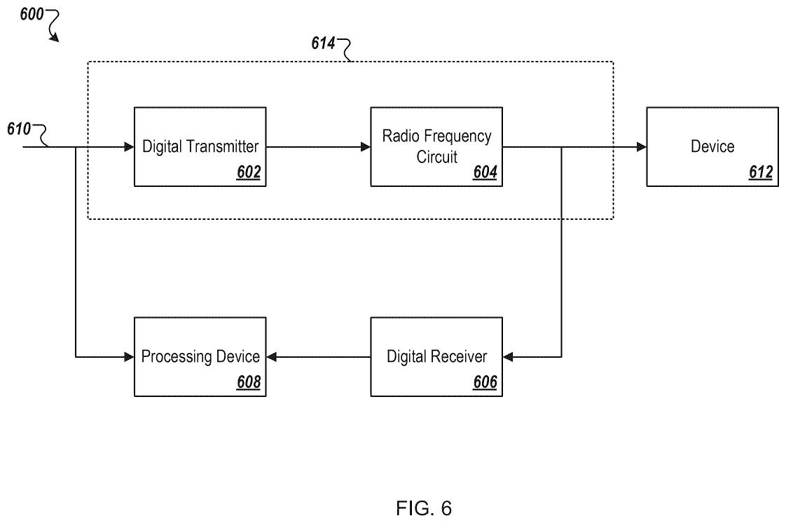

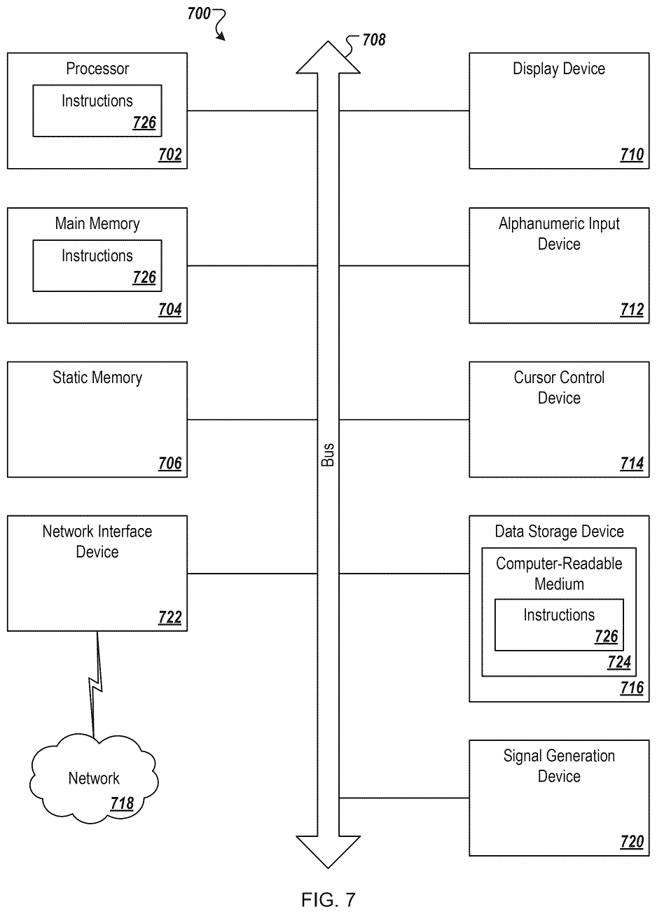

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 500 may begin at block 505 where the processing logic may connect DSPs to analog crossbars. At block 510, the processing logic may coordinate traffic between DSPs. The processing logic may coordinate one or more of a state or a configuration between DSPs. The processing logic may synchronize DSPs using a shared time base to minimize latency and timing drift during a traffic transition. The processing logic may use backpressure to avoid one or more of a data overflow or a collision between DSPs. The processing logic may use mutual exclusion to allocate resources.

Modifications, additions, or omissions may be made to the method 500 without departing from the scope of the present disclosure. For example, in some examples, the method 500 may include any number of other components that may not be explicitly illustrated or described.

In some examples, backpressure and flow control mechanisms are implemented to manage traffic flow and avoid overflows or collisions between digital signal processors (DSPs) in a high-speed data network. These mechanisms ensure efficient utilization of shared resources and minimize latency. The system may use various signaling protocols to achieve this, including Explicit Congestion Notification (ECN). ECN can be integrated into the Layer 2 (L2) or Layer 3 (L3) stack within the DSPs, where it marks packets as congestion is detected, enabling upstream clients to adjust transmission rates dynamically. By embedding this functionality within the DSP architecture, the system leverages the inherent capabilities of L2/L3 stacks to manage congestion without requiring external coordination.

In some examples, custom flow control protocols may also be employed to address the specific needs of the analog electrical circuit switch (AECS) environment. These protocols operate in-band, allowing DSPs to send flow control signals directly to connected clients. For instance, a token-based flow control system may be used, where DSPs issue tokens that grant clients permission to transmit data based on resource availability. This approach enables precise control over data transmission and ensures efficient use of bandwidth across the network.

In some examples, backpressure may be integrated with time-division multiplexing (TDM) cycles. The DSPs and crossbars can synchronize TDM allocations to dynamically adjust bandwidth usage. During periods of high congestion, DSPs can signal backpressure to temporarily defer certain TDM allocations. This synchronization ensures that high-priority traffic continues without interruption, while lower-priority traffic is managed efficiently to avoid bottlenecks.

In some examples, hardware mechanisms for implementing backpressure include input and output queues within each DSP. These queues are programmable and can dynamically adjust thresholds based on traffic patterns. Buffer management systems in DSPs and crossbars may monitor queue occupancy levels and generate backpressure signals when thresholds are exceeded. These signals instruct upstream devices to halt or slow incoming traffic until congestion subsides, thus preventing data loss and ensuring smooth traffic flow.

In some examples, the system may employ out-of-band (OOB) communication channels to facilitate backpressure signaling. Redundant analog crossbars provide OOB paths between DSPs and the switch controller, allowing congestion alerts and flow control signals to be transmitted independently of the primary data traffic. This OOB communication ensures that backpressure signals do not interfere with in-band data transmission and allows for precise coordination among network components during periods of high traffic.

In some examples, real-world scenarios illustrate the effectiveness of these backpressure mechanisms. For example, during a network failover event, the sudden redirection of traffic may result in temporary congestion. The DSPs can detect this increase in queue occupancy and immediately initiate backpressure signaling to upstream clients, instructing them to reduce transmission rates. Similarly, in high-latency environments, such as geographically distributed data centers, backpressure signals can be used to manage traffic spikes and avoid collisions, ensuring that all traffic flows are processed efficiently without degradation in performance. These implementations contribute to the system's ability to adapt dynamically to varying network conditions and maintain high levels of efficiency and reliability.

In some examples, synchronization across digital signal processors (DSPs) is achieved using advanced techniques to maintain timing alignment and ensure efficient traffic handling within high-speed networks. The system may employ a distributed synchronization model or a master-slave clock architecture, depending on the network topology and application requirements. In a master-slave configuration, a designated clock source, such as the switch controller or a specific DSP, provides a common timing reference for all other DSPs in the network. This central clock signal is distributed to the DSPs and crossbars, ensuring consistent timing across the system. Alternatively, in a distributed synchronization model, each DSP may include phase-locked loops (PLLs) to achieve local synchronization while maintaining overall system coherence.

In some examples, dynamic recalibration techniques are implemented to address timing drift and maintain synchronization during operation. The DSPs may use PLLs to continuously adjust their local clock signals based on reference inputs from the master clock or neighboring DSPs. This process minimizes jitter and symbol drift, which can otherwise degrade data integrity and increase latency. The PLLs may employ real-time feedback loops to detect and correct timing deviations dynamically, allowing the system to maintain high accuracy even in environments with fluctuating traffic loads or varying data rates.

In some examples, synchronization techniques may incorporate IEEE 1588 Precision Time Protocol (PTP) for high-accuracy clock alignment. The IEEE 1588 protocol enables the DSPs to exchange timestamped messages and calculate timing offsets, allowing for precise synchronization across all components. This method is particularly effective in complex network topologies, where maintaining consistent timing is critical for minimizing latency and ensuring seamless data flow. The integration of IEEE 1588 within the DSPs and crossbars provides a robust framework for achieving synchronization in diverse deployment scenarios.

In some examples, dynamic recalibration mechanisms may also include phase-alignment techniques to handle environmental changes, such as temperature variations, that can affect timing accuracy. DSPs equipped with phase detectors can continuously monitor the alignment of their clock signals relative to the master clock. When discrepancies are detected, the system dynamically adjusts the clock phase to restore alignment. These recalibration processes are performed without disrupting active traffic, ensuring uninterrupted operation and consistent performance.

In some examples, the synchronization framework is designed to adapt to varied data rates and complex topologies, such as those found in optical networks. The system may support multi-rate synchronization, allowing DSPs to operate at different data rates while maintaining overall timing coherence. For example, in an optical network with heterogeneous traffic types, the synchronization mechanisms ensure that high-speed and low-speed data flows are processed seamlessly without introducing latency or packet loss. This capability enhances the flexibility and scalability of the system, making it suitable for a wide range of applications.

In some examples, the synchronization techniques extend to the coordination of crossbar reconfiguration cycles. By aligning the reconfiguration schedules of DSPs and crossbars, the system minimizes latency and prevents timing mismatches during traffic transitions. This synchronization is critical in scenarios such as network failovers or load balancing, where rapid reconfiguration is required to maintain uninterrupted service. The combination of advanced synchronization methods and dynamic recalibration ensures that the system operates efficiently under all conditions, providing reliable performance and high data integrity.

In some examples, distributed processing is implemented to enable efficient management of traffic across multiple DSPs in the system. The distributed nature of processing allows for task allocation to be dynamically adjusted based on real-time network demands and system states. For instance, each DSP may be assigned specific subsets of traffic streams or crossbar resources to process, ensuring that the workload is evenly distributed and preventing bottlenecks. This dynamic allocation can be achieved through the use of in-band signaling, wherein traffic priorities or resource availability are communicated to the DSPs, allowing them to self-organize their processing tasks.

In some examples, Mutex mechanisms are employed to avoid resource contention and ensure smooth operation. Mutex protocols can be used to manage access to shared resources such as crossbar lanes or memory buffers. For example, when two DSPs attempt to access the same crossbar connection simultaneously, a Mutex mechanism ensures that only one DSP gains access at a time. This is achieved through coordination signals exchanged between the DSPs, ensuring that no collisions occur. As a practical example, if DSP 1 requests access to a high-priority crossbar lane currently in use by DSP 2, the Mutex mechanism may queue DSP 1's request until DSP 2 completes its operation. By avoiding simultaneous access, the system maintains data integrity and minimizes latency.

The allocation of processing tasks across DSPs can also adapt dynamically to changing network conditions. For example, during periods of high traffic in a specific DSP, the switch controller or an equivalent management mechanism can redistribute some of the traffic to neighboring DSPs with lighter workloads. This dynamic redistribution leverages real-time monitoring and synchronization between DSPs to ensure that traffic handling remains efficient and latency is minimized. In another scenario, distributed processing can prioritize certain DSPs for high-bandwidth or low-latency traffic while allocating less critical traffic to others, depending on the requirements of the application.

In some examples, collision avoidance is further supported by predictive algorithms implemented within the DSPs or the switch controller. These algorithms analyze historical traffic patterns and current load conditions to predict potential points of contention. For example, if a certain crossbar lane frequently experiences high demand during peak hours, the system can proactively reconfigure DSP assignments or reserve additional lanes to prevent congestion. This anticipatory approach complements the Mutex mechanism and enhances the overall efficiency of distributed processing.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 configured for synchronization, in accordance with at least one example described in the present disclosure. The communication system 600 may include a digital transmitter 602, a radio frequency circuit 604, a device 612, a digital receiver 606, and a processing device 608. The digital transmitter 602 and the processing device may be configured to receive a baseband signal via connection 610. A transceiver 614 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may be configured to obtain a baseband signal. For example, as described herein, the transceiver 614 may be configured to generate a baseband signal and/or receive a baseband signal from another device. In some examples, the transceiver 614 may be configured to transmit the baseband signal. For example, upon obtaining the baseband signal, the transceiver 614 may be configured to transmit the baseband signal to a separate device, such as the device 612. Alternatively, or additionally, the transceiver 614 may be configured to modify, condition, and/or transform the baseband signal in advance of transmitting the baseband signal. For example, the transceiver 614 may include a quadrature up-converter and/or a digital to analog converter (DAC) that may be configured to modify the baseband signal. Alternatively, or additionally, the transceiver 614 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an IEEE 1588v2 device, a Long-Term Evolution (LTE) physical layer (L-PHY), an (S-plane) device, a management plane (M-plane) device, an Ethernet MAC/personal communications service (PCS), a resource controller/scheduler, and the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may be configured to obtain the baseband signal for transmission. For example, the transceiver 614 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 614 may be configured to generate a baseband signal for transmission. In these and other examples, the transceiver 614 may be configured to transmit the baseband signal to another device, such as the device 612.

In some examples, the device 612 may be configured to receive a transmission from the transceiver 614. For example, the transceiver 614 may be configured to transmit a baseband signal to the device 612.

In some examples, the radio frequency circuit 604 may be configured to transmit the digital signal received from the digital transmitter 602. In some examples, the radio frequency circuit 604 may be configured to transmit the digital signal to the device 612 and/or the digital receiver 606. In some examples, the digital receiver 606 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may be configured to communicate with additional devices and/or systems remote from the processing device 608, such as the transceiver 614 and/or the device 612. For example, the processing device 608 may be configured to send and/or receive transmissions from the transceiver 614 and/or the device 612. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

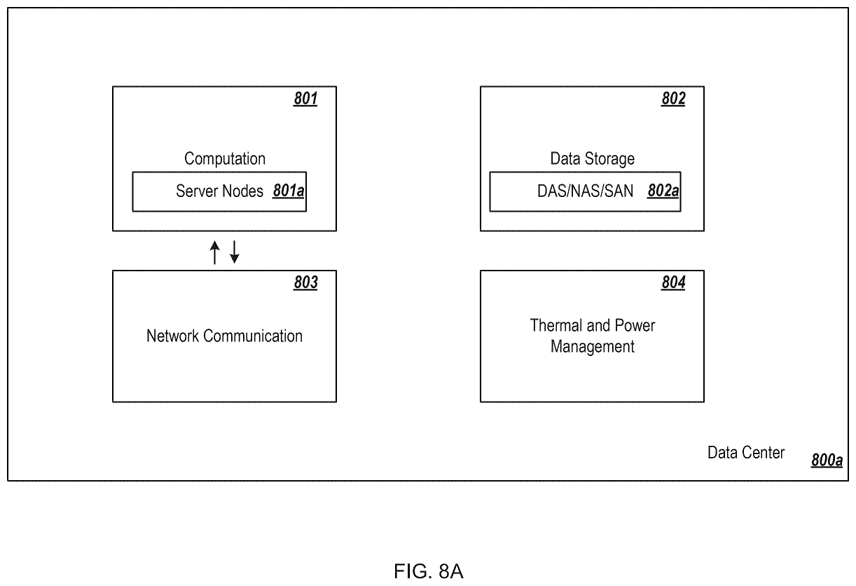

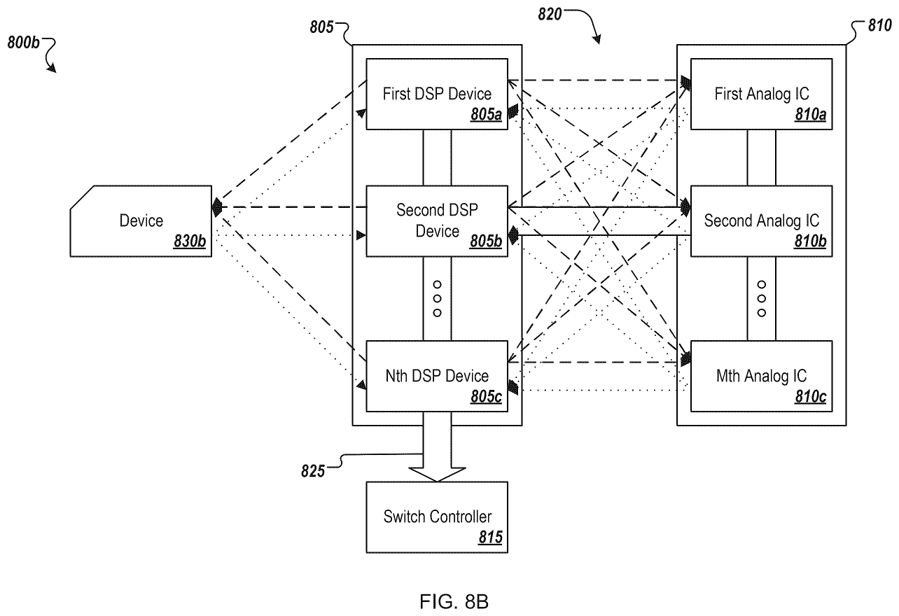

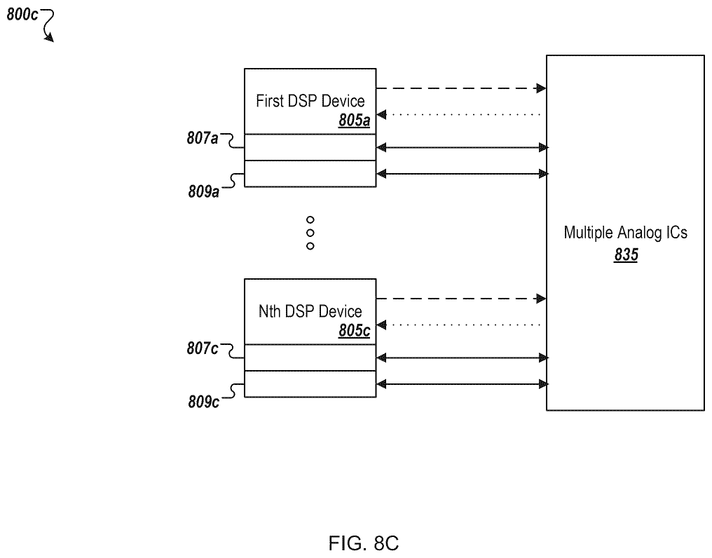

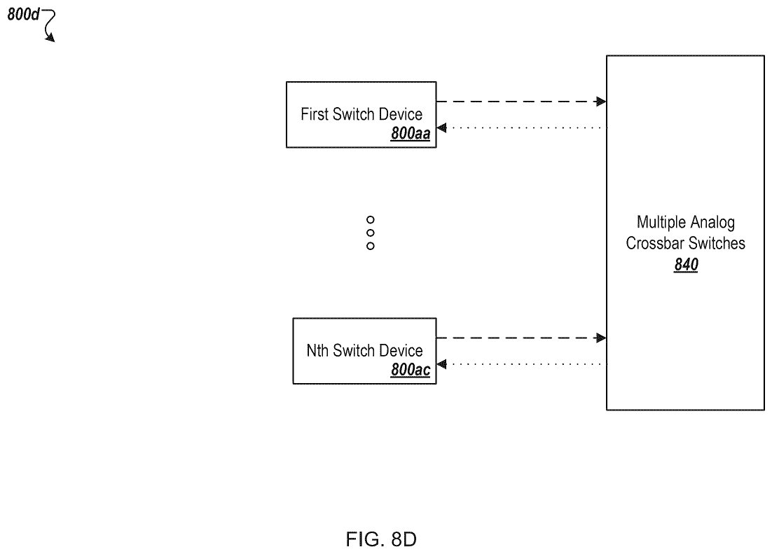

As illustrated in FIG. 8A, a block diagram of a data center 800a may include multiple subsystems configured to perform various operational functions, including computation 801, data storage 802, network communication 803, and thermal and power management 804. The computation 801 subsystem may include one or more server nodes 801a that may execute software applications and process data workloads. The data storage 802 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 802a. The networking communication 803 subsystem may facilitate bidirectional data transfer between servers and external networks through high-speed switching and routing components. The thermal and power management 804 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 800a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 8B illustrates an example switch device 800b. The switch device 800b may include a first digital signal processor (DSP) device 805a, a second DSP device 805b, an nth DSP device 805c, referred to collectively as multiple first electronic devices 805, a first analog integrated circuit (IC) 810a, a second analog IC 810b, an mth analog IC 810c, referred to collectively as multiple second electronic devices 810, a switch controller 815, in-band traffic 820, and out-of-band traffic 825. First DSP 805a, second DSP 805b, and nth DSP 805c may have input and output.

The switch device 800b may be reconfigurable (e.g., in terms of the connections between the components therein, such as the multiple first electronic devices 805 and the multiple second electronic devices 810, the switch controller 815, and/or a device 830), where the switching of the connections/lanes between the components may be low latency (e.g., less than 5 ns, 10 ns, or the like switching). Alternatively, or additionally, the switch device 800b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 805 may individually include one or more ports that may be used to facilitate communications within the switch device 800b, such as between the multiple first electronic devices 805 and the multiple second electronic devices 810, the switch controller 815, and/or a device 830. The communications in the switch device 800b may be transmitted via multiple lanes in the switch device 800b. The multiple lanes may facilitate the in-band traffic 820 and/or the out-of-band traffic 825.

The multiple lanes between the multiple first electronic devices 805 and the multiple second electronic devices 810 may be in an any-to-any configuration. For example, the first DSP device 805a may include a lane to the first analog IC 810a, to the second analog IC 810b, and/or the mth analog IC 810c. A similar arrangement may occur for each of the multiple first electronic devices 805, such that each DSP device of the multiple first electronic devices 805 may include a lane to any number of the multiple second electronic devices 810, including none of the multiple second electronic devices 810. Each lane for facilitating the in-band traffic 820 may be in both directions (e.g., transmit and receive) between the multiple first electronic devices 805, the multiple second electronic devices 810, and/or a device 830. Alternatively, or additionally, the lanes are dashed/dotted to illustrate that for any transmit/receive path between the multiple first electronic devices 805, the multiple second electronic devices 810, and/or a device 830, a lane may or may not be present.

The multiple first electronic devices 805, the multiple second electronic devices 810, and/or the switch controller 815 may be disposed on a printed circuit board (PCB) where traces on the PCB may be used to connect at least the multiple first electronic devices 805, the multiple second electronic devices 810, and/or the switch controller 815 (e.g., the traces on the PCB may facilitate the in-band traffic 820 and/or the out-of-band traffic 825 in the switch device 800b). Alternatively, or additionally, the multiple first electronic devices 805, the multiple second electronic devices 810, and/or the switch controller 815 may be connected to one another using connectors, such as high-speed cables, where the multiple first electronic devices 805, the multiple second electronic devices 810, and/or the switch controller 815 may individually include ports/headers to support the use of the connectors. In instances in which the connectors are used, crosstalk between the multiple lanes in the switch device 800b may be reduced relative to the crosstalk that may occur when the switch device 800b uses traces on a PCB.

The switch device 800b, including the multiple first electronic devices 805, the multiple second electronic devices 810, and/or the switch controller 815, may be utilized with one or more additional switches and/or crossbar devices to form a new crossbar switch device, which may be larger than any one of the switch devices 800b. For example, as illustrated and discussed relative to FIG. 8C, the switch device 800b may be utilized with any other number of switch devices 800b (e.g., the nth switch device 800ac in FIG. 8C) and multiple analog crossbar switches 840 to form a new crossbar switch device.

The multiple first electronic devices 805 may be digital signal processors (DSPs) and/or the multiple second electronic devices 810 may be analog circuit switch integrated circuits (ICs) for use with electrical signals. Alternatively, or additionally the multiple second electronic devices 810 may be analog optical circuit switch ICs for use with optical signals. The multiple first electronic devices 805 may be individually configured to support one or more layer of the open systems interconnection (OSI) model. For example, each of the multiple first electronic devices 805 may be configured to support layer 1 protocols, layer 2 protocols, and/or layer 3 protocols with respect to the in-band traffic 820 and/or the out-of-band traffic 825.

Each, or at least one, of the multiple first electronic devices 805 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 805 may be able to adjust the way in which traffic is directed through it, such as in response to a command from the switch controller 815. For example, each of the multiple first electronic devices 805 may be operable to configure an internal switch, an external switch, or a crossbar based on the various layer protocol processing to be performed.

The first DSP device 805a may receive a communication that includes a frame header (or a packet header) and the first DSP device 805a may be configured to detect the frame header and decode the frame header along with any associated contents of the communication, all within the first DSP device 805a. In a second example, the first DSP device 805a may integrate a media access control (MAC) address lookup table which may allow the first DSP device 805a to configure one or more crossbars such that the first DSP device 805a may facilitate connectivity between any two MAC addresses that are included in the lookup table. Alternatively, or additionally, each of the first electronic devices 805 may include a lookup table that may store equalization settings that may be used for various connections between the first electronic devices 805 and other components within the switch device 800b. The equalization settings in the lookup table may be used to accelerate acquisition and/or tracking for a particular DSP device of the multiple first electronic devices 805 when the particular DSP device switches connections within the switch device 800b.

The multiple first electronic devices 805 may be configured to respond to layer 2 protocol requests and/or layer 3 protocol requests for connectivity and/or resource grant requests. For example, the multiple first electronic devices 805 may compare a request to a lookup table that includes priority levels and the multiple first electronic devices 805 may be operable to configure themselves and/or associated crossbars and/or switches based on the determined priority level. Alternatively, or additionally, each of the multiple first electronic devices 805 may be configured to respond to in-band requests (e.g., granting a connection request, signaling backpressure to the device 830, etc.), collect statistics on traffic handled by the multiple first electronic devices 805 (e.g., link utilization and/or traffic type), and/or perform data filtering (e.g., detecting a particular header, performing routing, generating flags and/or interrupts, and/or logging any of the filtering events).

The multiple first electronic devices 805 may be configured to communicate with (e.g., transmit data to and/or receive data from) the device 830. The communication with the device 830 may include in-band traffic 820. In such instances, the communications between the multiple first electronic devices 805 and the device 830 may be line-side communications, where the lines may facilitate communications using various communication channels. For example, the line-side communications between the multiple first electronic devices 805 and the device 830 may be an electrical-to-electrical connection, an optical-to-optical connection, an electrical-to-optical connection, or an optical-to-electrical connection, and so forth.

The device 830 may address communications directly to one of the multiple first electronic devices 805. For example, the device 830 may address communications to the second DSP device 805b. Alternatively, or additionally, the device 830 may address communications to the switch controller 815, which may then direct communications to the appropriate DSP device. For example, the device 830 may address communications intended for the second DSP device 805b to the switch controller 815 and the switch controller 815 may direct the communications to the second DSP device 805b.

The multiple first electronic devices 805 may individually include memory that may be used as a buffer for communications through the multiple first electronic devices 805. The memory in the multiple first electronic devices 805 may be utilized to buffer incoming and/or outgoing traffic, which may include in-band traffic 820 and/or out-of-band traffic 825. Due to the memory in the multiple first electronic devices 805 being distributed (e.g., by the distributed nature of the multiple first electronic devices 805), the switch device 800b may not include any memory for buffering in addition to the memory included in the multiple first electronic devices 805.

The multiple first electronic devices 805 may individually include one or more additional lanes that may be used for communications in the switch device 800b. Further details associated with the additional lanes are included in the description associated with FIG. 8C.

The multiple second electronic devices 810 may individually include one or more ports that may be used to facilitate communications within the switch device 800b, similar to the ports described relative to the multiple first electronic devices 805. Alternatively, or additionally, the lanes for communications between the multiple first electronic devices 805 and the multiple second electronic devices 810 may be coupled with the ports included in the multiple second electronic devices 810.

The switch controller 815 may be a microcontroller unit (MCU). Alternatively, or additionally, the switch controller 815 may be a DSP, or other processing device. The switch controller 815 may be communicatively coupled with at least the multiple first electronic devices 805 and/or the multiple second electronic devices 810. The switch controller 815 may resolve resource grant requests, distribute the network state to the multiple first electronic devices 805 and/or to the multiple second electronic device 810, and/or may establish and/or maintain timing among the components included in the switch device 800b.

The switch controller 815 may communicate with the multiple first electronic devices 805 and/or the multiple second electronic devices 810 using a separate connection/lane than the connections between the multiple first electronic devices 805 and the multiple second electronic devices 810. For example, the first connection between the multiple first electronic devices 805 and the multiple second electronic devices 810 may facilitate the in-band traffic 820 and the second connection between the switch controller 815 and the multiple first electronic devices 805 and/or the multiple second electronic devices 810 may facilitate the out-of-band traffic 825.

The out-of-band traffic 825 may use a different network than the in-band traffic 820. Alternatively, or additionally, the out-of-band traffic 825 may use a different physical layer protocol than the in-band traffic 820. The out-of-band traffic 825 may be used to manage and/or configure one or more components included in the switch device 800b. For example, the switch controller 815 may communicate with the multiple first electronic devices 805 using the out-of-band traffic 825 to reconfigure lanes and/or traffic routing based on the traffic through the switch device 800b.

The switch controller 815 may be programmable such that the switch controller 815 may be operable to dynamically map the lanes between the multiple first electronic devices 805 and the multiple second electronic devices 810. For example, in instances in which the first DSP device 805a includes a lane to the first analog IC 810a, the switch controller 815 may dynamically map the lane to be from the first DSP device 805a to the second analog IC 810b. The switch controller 815 may dynamically adapt the mapping of the lanes between the multiple first electronic devices 805 and the multiple second electronic devices 810 based on one or more conditions and/or a satisfaction of a threshold related to the conditions. For example, in instances in which the real-time data traffic in the switch device 800b (or an amount of real-time data traffic handled by one of the multiple first electronic devices 805 and/or one of the multiple second electronic devices 810) satisfies a threshold, the switch controller 815 may dynamically adapt the mapping of the lanes as described.

The switch device 800b may include one or more redundant lanes that may be used in various situations during operation of the switch device 800b. For example, one or more redundant lanes may be used for the out-of-band traffic 825, such as signaling using the out-of-band traffic 825. In such instances, the out-of-band signaling may be transmitted and/or received by a particular DSP device and/or by the switch controller 815, and the out-of-band signaling may be a lower transmission rate than the in-band traffic 820. In another example, one or more redundant lanes may be used for out-of-bandwidth broadcasts from the switch controller 815 and/or from one or more of the multiple first electronic devices 805 to other devices in the switch device 800b (e.g., such as other DSP devices).

The switch controller 815 may reserve a portion of bandwidth associated with the in-band traffic 820 in the switch device 800b. The bandwidth reserved by the switch controller 815 may be reserved on a per lane basis of the multiple lanes included in the switch device 800b. For example, a first lane between the first DSP device 805a and the first analog IC 810a may have a first reserved bandwidth and a second lane between the second DSP device 805b and the second analog IC 810b may have a second reserved bandwidth, where the amount of bandwidth reserved may be the same or may differ between the first reserved bandwidth and the second reserved bandwidth. The switch controller 815 may allocate resources within the switch device 800b based on predicted or anticipated traffic (e.g., based on a probabilistic model).

Alternatively, or additionally, the switch controller 815 may monitor the lanes of the multiple lanes in the switch device 800b. The switch controller 815 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 815 may dynamically remap a new lane in the switch device 800b to replace the degraded lane.

The switch controller 815 may perform adaptive signal equalization to the in-band traffic 820 in the switch device 800b. For example, the multiple first electronic devices 805 may provide feedback to the switch controller 815 relative to the workload handled by the multiple first electronic devices 805, and the switch controller 815 may adaptively manage workloads of the multiple first electronic devices 805 to optimize performance of the switch device 800b.

A backup switch controller (not illustrated) may be included in the switch device 800b. The backup switch controller may be a redundant controller relative to the switch controller 815. The backup switch controller may include the same or similar connections as the switch controller 815 relative to the multiple first electronic devices 805 and/or the multiple second electronic devices 810. The backup switch controller may perform the same or similar operations as the switch controller 815.

FIG. 8C illustrates an example switch device 800c. The switch device 800c may include a first DSP device 805a, an nth DSP device 805c, and multiple analog ICs 835. The first DSP device 805a may include a first auxiliary channel 807a, and a first out-of-band channel 809a. The nth DSP device 805c may include an nth auxiliary channel 807c, and an nth out-of-band channel 809c.

The first DSP device 805a, the nth DSP device 805c, and the multiple analog ICs 835 may be the same or similar as the first DSP device 805a, the nth DSP device 805c, and the multiple second electronic devices 810, respectively, of FIG. 8A and may be operable to perform the same or similar functions as described.

The auxiliary channels 807 (e.g., the first auxiliary channel 807a and the second auxiliary channel 807c) may be individually utilized by each of the DSP devices 805a, 805c as an additional lane for in-band traffic between at least the DSP devices 805a, 805c and the multiple analog ICs 835. The auxiliary channels 807 may be used to redundantly transmit in-band traffic relative to another lane included in the DSP devices 805a, 805c prior to a change in configuration to the corresponding DSP devices 805a, 805c. For example, in instances in which the first DSP device 805a includes a lane to a particular analog IC of the multiple analog ICs 835 and the first DSP device 805a is to be reconfigured (e.g., by a switch controller as described herein), the first auxiliary channel 807a may have a lane mapped to the particular analog IC such that the in-band traffic is redundant between the first DSP device 805a and the particular analog IC prior to reconfiguring the lanes associated with the first DSP device 805a (which reconfiguration may otherwise break the connection between the first DSP device 805a and the particular analog IC).

The auxiliary channels 807 may be used for communication between other near DSP devices. For example, in instances in which the first DSP device 805a is disposed spatially near to the nth DSP device 805c, the first DSP device 805a and the nth DSP device 805c may communicate with one another via the auxiliary channels 807. Such communications may be possible as the channels between near-neighbors may be relatively clean, such that physical layer processing may be simplified and may result in power reduction, latency reduction, a lesser amount of equalization, and/or other benefits to the switch device 800c.

The out-of-band channels 809 may be used to communicate the out-of-band traffic (e.g., the out-of-band traffic 825 of FIG. 8B) on a lane separate from the multiple lanes used to communicate in-band traffic. In such instances, the out-of-band channels 809 may not cause blocking or interference to the in-band traffic between at least the DSP devices 805a, 805c and the multiple analog ICs 835.

FIG. 8D illustrates an example aggregated switch device 800d. The aggregated switch device 800d may include a first switch device 800aa, an nth switch device 800ac, and multiple analog crossbar switches 840. The first switch device 800aa and the nth switch device 800ac may individually be the same or similar as the switch device 800b of FIG. 8B.

The aggregated switch device 800d illustrates that any number of the switch devices 800b (e.g., the first switch device 800aa and the nth switch device 800ac) may be aggregated into another switch device and/or connected to other analog crossbar switches. Each of the switch devices 800b may include multiple DSP devices and multiple analog IC and may be further aggregated into the aggregated switch device 800d using the multiple analog crossbar switches 840. As such, the aggregated switch device 800d may be scaled up or down for any size communication need, by adjusting the switch devices 800b and/or the multiple analog crossbar switches 840 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars operable to be connected to the plurality of DSPs,
wherein the plurality of DSPs are operable to coordinate traffic between the plurality of DSPs.

2. The device of claim 1, wherein the plurality of DSPs are operable to coordinate one or more of a state or a configuration between the plurality of DSPs.

3. The device of claim 1, wherein the plurality of DSPs are coordinated using one or more of in-band (IB) communication or out-of-band (OOB) communication.

4. The device of claim 1, wherein the plurality of DSPs are coordinated using asynchronous coordination.

5. The device of claim 1, wherein the plurality of DSPs are coordinated using ad hoc coordination.

6. The device of claim 1, wherein the plurality of DSPs are operable to synchronize the plurality of DSPs using a shared time base to minimize latency and timing drift during a traffic transition.

7. The device of claim 6, wherein the plurality of DSPs are synchronized using Institute of Electrical and Electronics Engineers (IEEE) 1588.

8. The device of claim 1, wherein the plurality of DSPs are operable to use backpressure to avoid one or more of a data overflow or a collision between the plurality of DSPs.

9. The device of claim 1, wherein the plurality of DSPs are operable to use mutual exclusion.

10. The device of claim 1, wherein a switch controller is operable to coordinate traffic between the plurality of DSPs.

11. The device of claim 1, wherein a plurality of connections between the plurality of DSPs and the plurality of analog crossbars is periodically changed to facilitate communication.

12. The device of claim 1, wherein one or more crossbar inputs are provisioned to facilitate control and management of the device.

13. A device, comprising:
a plurality of digital signal processors (DSPs);
a plurality of analog crossbars operable to be connected to the plurality of DSPs; and
a switch controller operable to coordinate traffic between the plurality of DSPs.

14. The device of claim 13, wherein the switch controller is operable to facilitate failover.

15. The device of claim 13, wherein the switch controller is operable to reserve in-band bandwidth.

16. A method, comprising:
connecting a plurality of digital signal processors (DSPs) to a plurality of analog crossbars; and
coordinating traffic between the plurality of DSPs.

17. The method of claim 16, further comprising coordinating one or more of a state or a configuration between the plurality of DSPs.

18. The method of claim 16, further comprising synchronizing the plurality of DSPs using a shared time base to minimize latency and timing drift during a traffic transition.

19. The method of claim 16, further comprising using backpressure to avoid one or more of a data overflow or a collision between the plurality of DSPs.

20. The method of claim 16, further comprising using mutual exclusion to allocate resources.
